(19) United States
(12) Patent Application Publication
(10) Pub. No.: US 2023/0198049 A1
(43) Pub. Date: Jun. 22, 2023

(54) COOLING PLATE OF A BATTERY MODULE OF A TRACTION BATTERY OF A MOTOR VEHICLE, METHOD FOR PRODUCING SAME, AND BATTERY MODULE

(71) Applicants: Dr. Ing. h.c. F. Porsche Aktiengesellschaft, Stuttgart (DE); Rimac Automobiles Ltd., Sveta Nedelja (HR)

(72) Inventors: Fadi Renz, Kornwestheim (DE); Inge Vinkovic, Samobor (HR); Stavros Patiniotis, Zagreb (HR)

(73) Assignees: Dr. Ing. h.c. F. Porsche Aktiengesellschaft, Stuttgart (DE); Rimac Automobiles Ltd., Sveta Nedelja (HR)

(21) Appl. No.: 18/079,168

(22) Filed: Dec. 12, 2022

(30) Foreign Application Priority Data
Dec. 16, 2021 (DE) 10 2021 133 513.2

(51) Int. Cl. H01M 10/6556; B60L 50/64; H01M 10/613

(52) U.S. Cl. CPC H01M 10/6556; B60L 50/64; H01M 10/613

(57) ABSTRACT

A cooling plate of a battery module of a traction battery of a motor vehicle includes a first plate body connected to a second plate body. A coolant inflow is formed by the first plate body and the second plate body at a first side of the cooling plate. A coolant outflow is formed by the first plate body and the second plate body at a second side of the cooling plate. Coolant channels are formed by the first plate body and the second plate body. A first coolant channel coupled to the coolant inflow extends from the first side towards the second side. A second coolant channel coupled to the first coolant channel extends from the second side towards the first side. A third coolant channel coupled to the second coolant channel and the coolant outflow extends from the first side towards the second side.

### CROSS-REFERENCE TO RELATED APPLICATION

This application claims priority to German Patent Application No. 10 2021 133 513.2, filed Dec. 16, 2021, the content of such application being incorporated by reference herein in its entirety.

### FIELD OF THE INVENTION

The invention relates to a cooling plate of a battery module of a traction battery of a motor vehicle. Furthermore, the invention relates to a method for producing such a cooling plate and to a battery module.

### BACKGROUND OF THE INVENTION

Traction batteries are installed in motor vehicles, such as hybrid vehicles or electric vehicles, and are used to store electrical energy in order to supply this energy to an electric machine. Traction batteries have a plurality of battery modules that are electrically interconnected. Each battery module has a plurality of battery cells that are also electrically interconnected. During operation, the battery cells are subject to heating, for example as a result of chemical reactions within the battery cells. To prevent damage to the battery modules and thus to the traction battery as a result of overheating of the battery cells, heat must be dissipated from the traction battery by cooling the battery cells. It is already known to cool the battery cells of a traction battery. For this purpose, a battery module of a traction battery has a device for cooling the battery cells.

DE 20 2012 006 560 U1, which is incorporated by reference herein, discloses a water cooling plate for a battery pack. The water cooling plate has a first plate, a second plate, and a channel structure sandwiched between the first plate and the second plate. Further, the water cooling plate has a separate connector forming a water inflow and a water outflow. The two plates and the channel structure are formed by stamping, with these assemblies being joined together by welding.

CN 207 967 246 U, which is incorporated by reference herein, discloses a cooling device for a motor vehicle battery. The cooling device is composed of plates, wherein a separate inflow and a separate outflow for coolant are formed on an upper plate. The cooling plate is used here to cool a plurality of battery modules.

Further prior art is known from DE 11 215 000 600 T5 and CN 207 250 677 U, which are each incorporated by reference herein.

### SUMMARY OF THE INVENTION

There may exist a need for a cooling plate of a battery module of a traction battery for cooling a plurality of battery cells of the battery module, which cooling plate has a simple structure and can be easily produced. There may also exist a need for a battery module comprising such a cooling plate and for a method for producing the cooling plate.

The cooling plate according to aspects of the invention has a first plate body and a second plate body connected to the first plate body. The cooling plate according to aspects of the invention comprises a coolant inflow defined or formed by the first plate body and the second plate body at a first side of the cooling plate. The cooling plate according to aspects of the invention further comprises a coolant outlet defined or formed by the first plate body and the second plate body at a second side of the cooling plate. The cooling plate according to aspects of the invention further comprises coolant channels defined or formed by the first plate body and the second plate body, wherein a first coolant channel coupled to the coolant inflow extends from the first side towards the second side, wherein a second coolant channel coupled to the first coolant channel extends from the second side towards the first side, and wherein a third coolant channel coupled to the second coolant channel and the coolant outlet extends from the first side towards the second side.

The cooling plate according to aspects of the invention is composed of the first plate body and the second plate body. The two plate bodies define or form both the coolant inflow and the coolant outflow as well as the coolant channels extending between the coolant inflow and the coolant outflow. Therefore, the cooling plate according to aspects of the invention is formed by only two assemblies, namely the two plate bodies. However, the cooling plate has a simple structure and can be easily produced.

Preferably, the coolant inflow, the coolant channels, and the coolant outflow are delimited in some portions by portions of the plate bodies that abut one another and are connected to one another. The mutually abutting and interconnected portions of the plate bodies are formed by elevations of the plate bodies, wherein recesses of the plate bodies extend between the elevations of the plate bodies and are spaced apart from one another and enclose the coolant inflow, the coolant channels and the coolant outflow. This permits particularly simple production of the cooling plate.

Preferably, the coolant inflow, the coolant channels and the coolant outflow are integral components of the plate bodies. The number of assemblies of the cooling plate is reduced to just two, which makes the cooling plate particularly easy to produce.

Preferably, the plate bodies are formed from stamped metal sheets which are soldered to one another. This is particularly preferred in order to make the cooling plate according to aspects of the invention easy to produce.

Preferably, in a transition region between the coolant inflow and the first coolant channel and/or in a transition region between the third coolant channel and the coolant outflow, round or oval portions of the plate bodies rest against one another and are connected to one another. On the one hand, the round or oval portions promote an advantageous flow guidance in the transition region in question, and on the other hand they give the cooling plate a high degree of stability even at high flow pressures.

Preferably, bent or curved, in particular sickle-shaped portions of the plate bodies rest against one another in a transition region between the first coolant channel and the second coolant channel and/or in a transition region between the second coolant channel and the third coolant channel and are connected to one another. The bent or curved, in particular sickle-shaped portions also promote the flow guidance of the cooling fluid and give the cooling plate a high degree of stability even at high flow pressures.

### BRIEF DESCRIPTION OF THE DRAWINGS

Preferred developments of the invention can be found in the claims and the following description. Exemplary embodiments of the invention are explained in greater detail, without being limited thereto, by reference to the drawing, in which:

FIG. 1 shows a perspective view of a device for cooling battery cells of a battery module of a traction battery of a motor vehicle;

FIG. 2 shows a side view of one of the cooling plates of the device of FIG. 1,

FIG. 3 shows a perspective view of the cooling plate of FIG. 2,

FIG. 4 shows an exploded view of FIG. 3,

FIG. 5 shows a first cross-section through FIG. 3,

FIG. 6 shows the cross-section of FIG. 5 in another perspective view,

FIG. 7 shows a second cross-section through FIG. 3, and

FIG. 8 shows the cross-section of FIG. 7 in another perspective view.

### DETAILED DESCRIPTION OF THE INVENTION

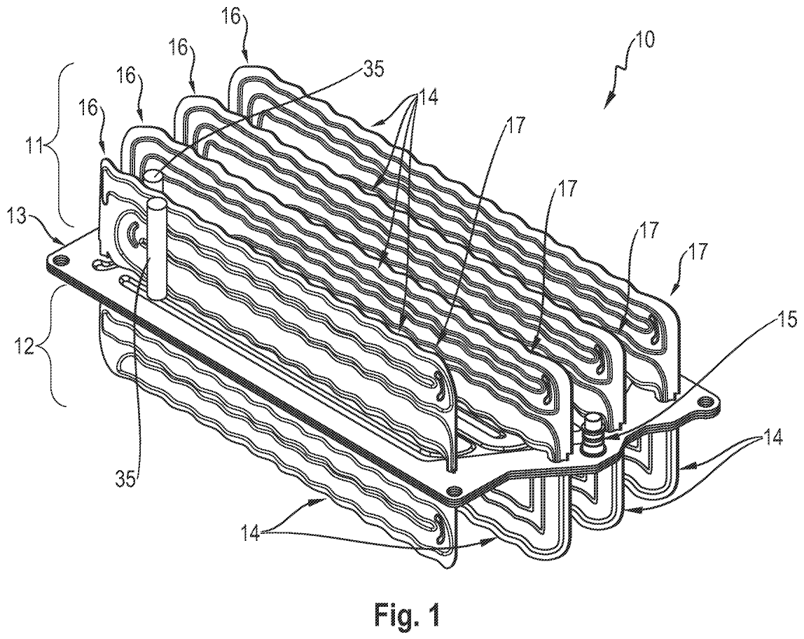

FIG. 1 shows a perspective view of a preferred exemplary embodiment of a device 10 for cooling battery cells 35 of a battery module of a traction battery of a motor vehicle. In FIG. 1, only two battery cells 35 are shown.

The arrangement from FIG. 1 can be received in a module housing (not shown) of the battery module.

The battery cells 35 are arranged in two battery cell levels 11, 12 arranged one above the other. Thus, multiple battery cells 35 are arranged in a first or upper battery cell level 11 and in a second or lower battery cell level 12. As already explained, only two battery cells 35 are shown in FIG. 1, both of which are arranged in the upper battery cell level 11.

The device 10 for cooling the battery cells 35 has a first cooling plate 13, which is arranged between the first battery cell level 11 and the second battery cell level 12 and which, via its outer sides, is in thermal contact with the battery cells 35 of the first battery cell level 11 and is in thermal contact with the battery cells 35 of the second battery cell level 12.

Thus, in FIG. 1, the first cooling plate 13 is in thermal contact via a first outer side with a lower side of the battery cells 35 of the first battery cell level 11 and via a second outer side with an upper side of the battery cells 35 of the second battery cell level 12.

Electrical contacts (not shown) of the battery cells 35 are formed in the first battery cell level 11 on the upper side of the battery cells 35 and in the second battery cell level 12 on the lower side of the battery cells 35. Those sides of the battery cell 35 on which electrical contacts (not shown) of the battery cells are formed thus face away from the first cooling plate 13.

Accordingly, the battery cells 35 of the battery module abut the first cooling plate 13 of the cooling device 10, namely the outer sides of the first cooling plate 13, by means of the sides facing away from the electrical contacts of the battery cells 35.

A cooling fluid flows through the first cooling plate 13. The first cooling plate 13 can have a sandwich-like structure consisting of preferably three plate bodies. It is possible that the first cooling plate 13 is also formed by only two plate bodies. It is also possible that the first cooling plate 13 is a monolithic assembly produced, for example, by 3D printing. Then, if the first cooling plate 13 is formed from two plate bodies, these plate bodies form the outer sides of the first cooling plate 13 via which the first cooling plate 13 is in thermal contact with the battery cells of the two battery cell levels. These two plate bodies then define the flow channels of the first cooling plate 13 for the cooling medium.

In addition to the first cooling plate 13, the device 10 for cooling the battery cells 35 has a plurality of second cooling plates 14, which are formed in accordance with the invention. Thus, as can be seen from FIG. 1, which shows the device 10 for cooling the battery, a plurality of second cooling plates 14, four in the exemplary embodiment shown, are arranged in each battery cell level 11, 12. The second cooling plates 14, similarly to the first cooling plate 13, have the cooling fluid flowing through them, wherein each of the second cooling plates 14 is in thermal contact with a plurality of battery cells 35 of each battery cell level 11, 12, more specifically in such a way that each of the second cooling plates 14 is in thermal contact on each side thereof with a row of battery cells 35. The two battery cells 35 shown in FIG. 1 are in thermal contact with the front second cooling plate 14 at the upper battery cell level 11.

The device 10 further has a cooling fluid inlet (not visible) or cooling fluid inflow and a cooling fluid outlet 15 or cooling fluid outflow. In FIG. 1, only the cooling fluid outlet 15 is visible. Cooling fluid flows into the first cooling plate 13, namely the flow channels of the first cooling plate 13, via the cooling fluid inlet (not visible). A first part of this cooling fluid flowing into the first cooling plate 13 via the cooling fluid inlet flows exclusively through the first cooling plate 13 in the direction of the opposite second side of the first cooling plate 13, in order to flow out of the first cooling plate 13 on this opposite second side of the first cooling plate 13 via the cooling fluid outlet 15.

A second part of the cooling fluid flowing into the first cooling plate 13 via the cooling fluid inlet (not visible) flows from the first cooling plate 13 into the second cooling plates 14 on the first side of the first cooling plate 13, flows through the second cooling plates 14, and flows from the second cooling plates 14 back into the first cooling plate 13 on the second opposite side of the first cooling plate 13, in order to then flow out of the first cooling plate 13 again on the second side of the first cooling plate 13 via the cooling fluid outlet 15 and thus out of the device 10 to cool the battery cells 35.

The second cooling plates 14 have a corrugated course or wave contour in the longitudinal direction, i.e., between a first side 16 of each second cooling plate 14 and an opposite second side 17 of each second cooling plate 14. This corrugated course or wave contour of the second cooling plates 14 is adapted to the contour of the battery cells 35 to be cooled, which extend in rows along the second cooling plates 14.

At the opposite sides of the second cooling plates 14, these have a coolant inflow 18 and a coolant outflow 19, namely at a first side 16 they have a coolant inflow 18 and at an opposite second side 17 they have a coolant outflow 19. Via the coolant inflow 18, the second part of the cooling fluid flowing into the first cooling plate 13 can flow over from the first cooling plate 13 into a second cooling plate 14. After flowing through the various second cooling plates 14, the cooling fluid can exit via the relevant coolant outflow 19 and can flow back into the first cooling plate 13 to be subsequently discharged via the cooling fluid outlet 15.

In addition to the coolant inflow 18 formed at the first side 16 of a second cooling plate 14 and the coolant outflow 19 formed at the opposite second side 17 of a second cooling plate 14, the second cooling plate 14 in question has cooling channels 20, 21, 22 extending in the longitudinal direction between the first side 16 and the second side 17.

A first coolant channel 20 of a second coolant plate 14, coupled to the coolant inflow 18, extends from the first side 16 of the second coolant plate 14 towards the second side 17 of the second coolant plate 14.

A second coolant channel 21 of a second coolant plate 14, which is coupled to the first coolant channel 20 in the region of the second side 17, extends from the second side 17 of the second coolant plate 14 towards the first side 16 of the second coolant plate 14.

A third coolant channel 22 of a second coolant plate 14, which is coupled to the second coolant channel 21 in the region of the first side 16 of the second coolant plate 14, extends from the first side 16 of the second coolant plate 14 towards the second side 17 of the second coolant plate 14 and is coupled there to the coolant outflow 19.

Each second cooling plate 14 is formed from a first plate body 14a and a second plate body 14b, as can best be seen from the exploded view of FIG. 4.

The two plate bodies 14a, 14b form both the above-mentioned coolant inflow 18 and the above-mentioned coolant outflow 19, as well as the above-mentioned coolant channels 20, 21, 22.

Accordingly, each second cooling plate 14 is formed by exclusively two assemblies, namely by the two plate bodies 14a, 14b. The two plate bodies 14a, 14b define and form both the coolant inflow 18 and the coolant outflow 19 of the second cooling plate 14, as well as the coolant channels 20, 21, 22 of the second cooling plate 14 extending in the longitudinal direction of the second cooling plate 14. The coolant inflow 18, the coolant outflow 19 and the coolant channels 20, 21, 22 are integral components here of the plate bodies 14a, 14b of the second cooling plate 14.

The coolant inflow 18, the coolant outflow 19 and the coolant channels 20, 21 and 22 of each second cooling plate 14 are delimited in portions by portions of the plate bodies 14a, 14b which abut one another and are connected to one another. Thus, these mutually abutting and interconnected portions of the plate bodies 14a, 14b are formed by elevations 23, 24 of the plate bodies 14a, 14b. Between these elevations 23, 24 of the plate bodies 14a, 14b there extend recesses 25, 26 which do not abut one another but rather are spaced apart from one another and enclose the coolant inflow 18, the coolant outflow 19 and the coolant channels 20, 21 and 22.

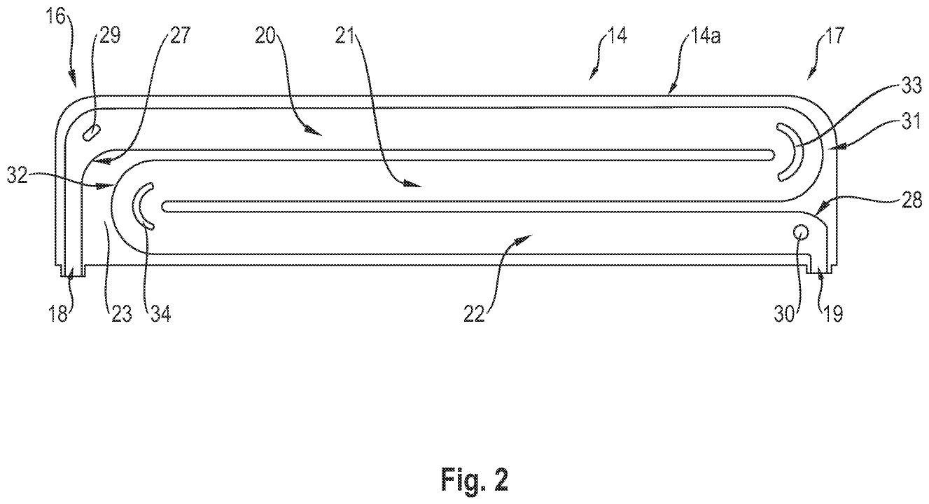

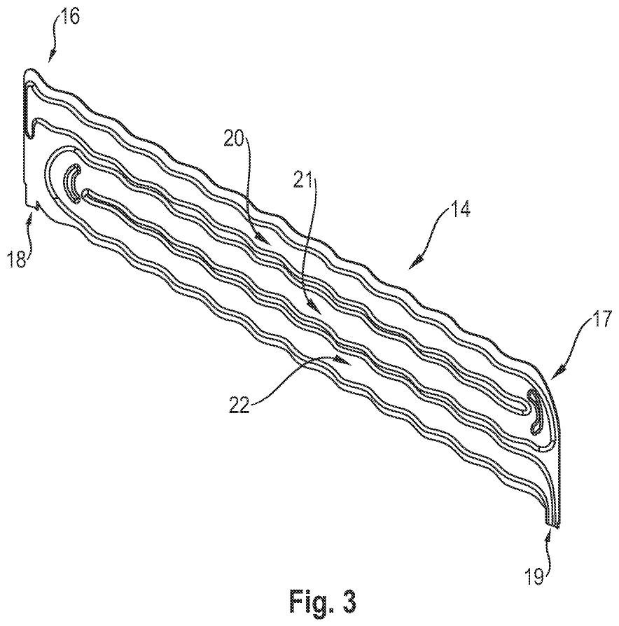

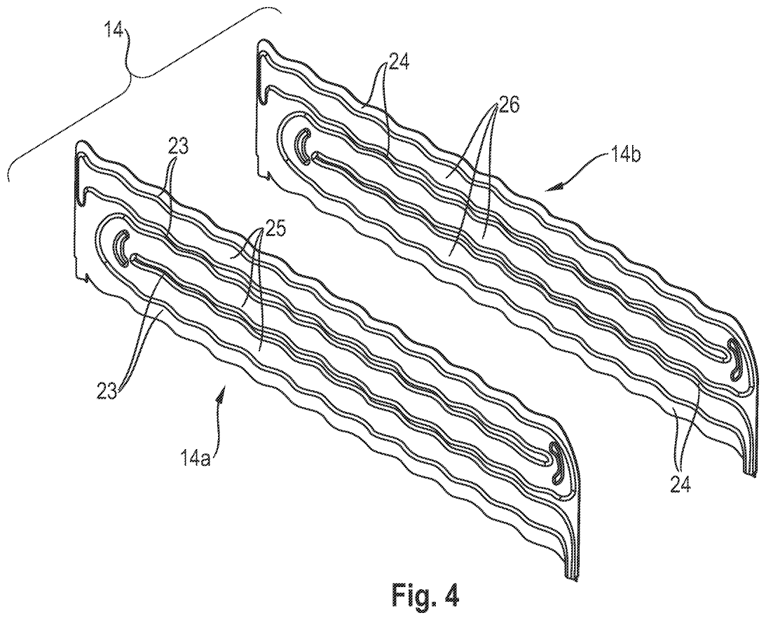

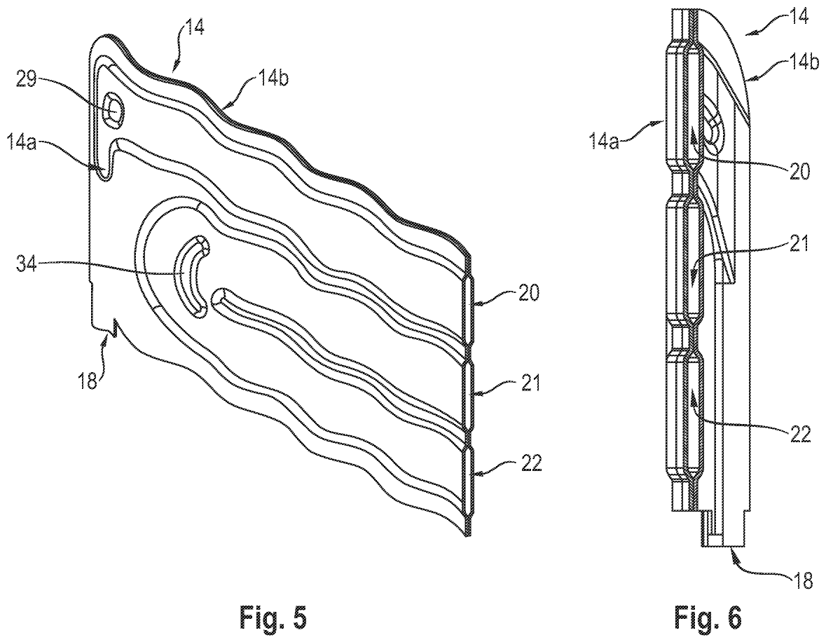

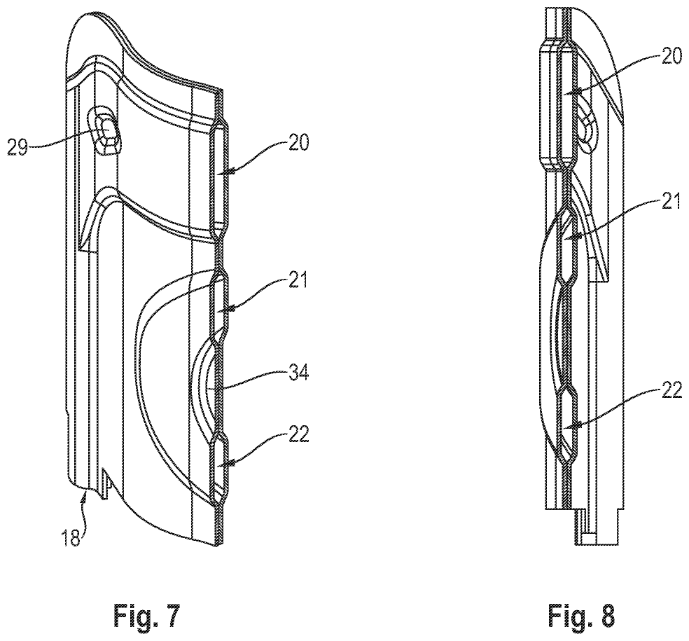

As can best be seen from FIG. 2, in a transition region 27 between the coolant inflow 18 and the first coolant channel 20, the transition region being formed in the region of the first side 16 of the second cooling plate 14, and in a transition region 28 between the third coolant channel 22 and the coolant outflow 19, the transition region being formed in the region of the second side 17 of the second cooling plate 14, portions which are formed by the elevations 23, 24 of the plate bodies 14a, 14b and which rest against one another are connected to one another. An oval element 29 is hereby formed in the transition region 27, and a round element 30 is formed in the transition region 28. These elements 29 and 30 increase the stability of the second cooling plate 14 in the transition regions 27 and 28. Furthermore, these elements 29, 30 prevent the two plate bodies 14a, 14b from moving away from each other when a high fluid pressure is applied and prevent the second cooling plate 14 from deforming or inflating. Furthermore, these elements 29 and 30 promote the flow guidance of the cooling fluid in the transition regions 27 and 28.

In FIG. 4, in a transition region 31 between the first coolant channel 20 and the second coolant channel 21, the transition region being formed in the region of the second side 17 of the second cooling plate 14, as well as in a transition region 32 between the second coolant channel 21 and the third coolant channel 22, the transition region being formed in the region of the first side 16 of the second cooling plate 14, elements 33, 34 are also formed one in each transition region and increase the mechanical stability of the second cooling plate 14 in the transition regions 31, 32 and improve the flow guidance of the cooling fluid in the transition regions 31, 32. In these transition regions 31, 32, these elements 33, 34 are formed by bent or curved, in particular sickle-shaped portions of the plate bodies 14a, 14b, which in turn are provided by the elevations 23, 24 of the plate bodies 14a, 14b.

As already explained, each second cooling plate 14 is formed by only two assemblies, namely by the two plate bodies 14a, 14b. The plate bodies 14a, 14b are bodies formed from stamped metal sheets which are soldered to one another.

The invention relates both to a cooling plate 14 alone, and to a battery module comprising a plurality of such cooling plates 14. In the exemplary embodiment shown, the cooling plates according to aspects of the invention form the second cooling plates 14 of the device 10 for cooling the battery cells 35.

For the production of a cooling plate 14 according to aspects of the invention, at least one metal sheet is provided, wherein the plate bodies 14a, 14b are formed from the at least one metal sheet by stamping. In this process, the plate bodies 14a, 14b can be brought into the corrugated shape. Subsequently, the plate bodies 14a, 14b formed by stamping are connected to one another, namely by soldering. In this process, a solder paste is applied to the elevations of the plate bodies 14a, 14b, which rest against each other and are connected to one another following production. During soldering, the plate bodies 14a, 14b are joined to one another over their entire surface in the region of their elevations 23 and 24 resting against one another, more specifically also in the region of the elements 29, 30, 33 and 34.

The cooling plate according to aspects of the invention, and thus the device for cooling the battery cells of a battery module, and thus the battery module, has a structure and can be easily produced.

What is claimed is:

1. A cooling plate of a battery module of a traction battery of a motor vehicle for cooling battery cells of the battery module, said cooling plate comprising:
a first plate body,
a second plate body connected to the first plate body,
a coolant inflow formed by the first plate body and the second plate body at a first side of the cooling plate,
a coolant outflow formed by the first plate body and the second plate body at a second side of the cooling plate, and
coolant channels formed by the first plate body and the second plate body,
wherein a first coolant channel fluidly coupled to the coolant inflow extends from the first side towards the second side,
wherein a second coolant channel fluidly coupled to the first coolant channel extends from the second side towards the first side, and
wherein a third coolant channel fluidly coupled to the second coolant channel and the coolant outflow extends from the first side towards the second side.

2. The cooling plate as claimed in claim 1, wherein the coolant inflow, the coolant channels and the coolant outflow are delimited in portions by portions of the plate bodies which rest against one another and are connected to one another.

3. The cooling plate as claimed in claim 2, wherein
the portions of the plate bodies resting against one another and connected to one another are formed by elevations formed in the plate bodies, and
recesses of the plate bodies extend between the elevations of the plate bodies and are spaced apart from one another and enclose the coolant inflow, the coolant channels and the coolant outflow.

4. The cooling plate as claimed in claim 1, wherein the coolant inflow, the coolant channels and the coolant outflow are integral components of the plate bodies.

5. The cooling plate as claimed in claim 1, wherein:
in a transition region between the coolant inflow and the first coolant channel, round or oval portions of the plate bodies rest against one another and are connected to one another, and/or
in a transition region between the third coolant channel and the coolant outflow, round or oval portions of the plate bodies rest against one another and are connected to one another.

6. The cooling plate as claimed in claim 1, wherein:
in a transition region between the first coolant channel and the second coolant channel, bent, curved or sickle-shaped portions of the plate bodies rest against one another and are connected to one another, and/or
in a transition region between the second coolant channel and the third coolant channel, bent, curved or sickle-shaped portions of the plate bodies rest against one another and are connected to one another.

7. The cooling plate as claimed in claim 1, wherein the plate bodies comprise stamped metal sheets which are soldered to one another.

8. The cooling plate as claimed in claim 1, wherein the cooling plate is configured to cool a plurality of battery cells of the battery module of the traction battery, and the cooling plate between the first side and the second side has a corrugated course adapted to a contour of the battery cells to be cooled of the battery module of the traction battery.

9. A battery module comprising the cooling plate of claim 1.

10. A traction battery comprising the battery module of claim 9.

11. A motor vehicle comprising the traction battery of claim 10.

12. A battery module of a traction battery of a motor vehicle, said battery module comprising:
a plurality of battery cells arranged in at least two battery cell levels positioned one above the other,
a device for cooling the plurality of battery cells, said device including:
a first cooling plate, which is arranged between a first battery cell level and a second battery cell level of the at least two battery cell levels and which is in thermal contact with the battery cells of the first and second battery cell levels, and
second cooling plates arranged within the first battery cell level and further second cooling plates arranged within the second battery cell level, said second and further second cooling plates being in thermal contact with a plurality of battery cells of the corresponding battery cell level,
wherein each of the second cooling plates is a cooling plate according to claim 1.

13. A method for producing a cooling plate of a battery module of a traction battery, said method comprising the following steps:
forming a first plate body and a second plate body from at least one metal sheet by stamping,
soldering the second plate body to the first plate body,
forming a coolant inflow by the first plate body and the second plate body at a first side of the cooling plate,
forming a coolant outflow by the first plate body and the second plate body at a second side of the cooling plate,
forming coolant channels by the first plate body and the second plate body,
wherein a first coolant channel fluidly coupled to the coolant inflow extends from the first side towards the second side,
wherein a second coolant channel fluidly coupled to the first coolant channel extends from the second side towards the first side, and
wherein a third coolant channel fluidly coupled to the second coolant channel and the coolant outflow extends from the first side towards the second side.
